(19) United States
(12) Patent Application Publication
(10) Pub. No.: US 2022/0047438 A1
(43) Pub. Date: Feb. 17, 2022

(54) Assistive Wheelchair

(71) Applicant: Trimatech S.R.L., Torre Boldone (IT)

(72) Inventors: Riccardo Tripepi, Bergamo (IT); Massimo Tripepi, Bergamo (IT)

(73) Assignee: Trimatech S.R.L., Torre Boldone (IT)

(21) Appl. No.: 17/233,406

(22) Filed: Apr. 16, 2021

Related U.S. Application Data
(60) Provisional application No. 63/066,801, filed on Aug. 17, 2020.

(51) Int. Cl. A61G 5/14; A61G 5/04; A61G 5/10; A61G 5/12

(52) U.S. Cl. CPC A61G 5/14; A61G 5/04; A61G 5/1002; A61G 5/122; A61G 5/1062; A61G 5/1059; A61G 5/127; A61G 5/104

(57) ABSTRACT

An assistive wheelchair that provides stand-up capability, vertical height adjustment while seated, and independent toileting is disclosed. The assistive wheelchair includes a verticalization system to move the user from a sitting to a more vertical position by tilting the while maintaining the proper center of gravity through the use of actuators and multi-bar linkages. The verticalization system also allows the seat to move up and down without modifying its tilt angle in order to change the height of the seat. An opening system provides for transversal movement of the wheels, to increase the width of the base of the wheelchair in order to create a space wide enough between the wheels to fit over a lavatory. A trap door seat is also provided that is lowered and moved from under the wheelchair to provide an opening in the wheelchair main seat during toileting.

### RELATED APPLICATIONS

This patent claims priority to U.S. provisional application 63/066,801 filed Aug. 17, 2020, which is incorporated here by reference in its entirety.

### TECHNICAL FIELD

The present disclosure relates to an assistive wheelchair that provides increased independence to wheelchair bound individuals and, more specifically, a motorized wheelchair with stand-up capability, vertical height adjustment while seated, and independent toileting through the provision of transversal movement of wheels to widen the base of the wheelchair while in use. The ability for the wheelchair to widen the base while in use for toileting and to transition between accommodation for a seated position and a standing position that also allows movement while standing provides increased independence to the user.

### BACKGROUND

It has long been recognized that sitting in a wheelchair for excessive amounts of time negatively impacts the wheelchair bound. Persons confined to wheelchairs become uncomfortable and psychologically depressed after prolonged periods of being seated, and in situations wherein being seated is inappropriate. Physically, sitting for long periods of time also results in bedsores and cardiovascular difficulties, among other physical problems. When people sit for more than eight hours each day, blood flows less efficiently, which can deprive cells of nutrients and oxygen. Compounding the problem, the muscles cannot burn fat as quickly. Thus, fatty acids accumulate throughout the body, and can interfere with the functioning of the heart. Inactive muscles also do not react to insulin effectively, which leads the body to secrete excessive quantities of insulin, increasing the likelihood of diabetes.

In situations where other persons are seated the height of the wheelchair seat may not be optimal, such as when seated at a pub-style table with high stools. In situations where it is inappropriate to be seated, as in some work environments, business or social circumstances, persons confined to a wheelchair may perform and feel more comfortable when in a standing position, or if the seat of the wheelchair is elevated vertically to match the height of other seats. In addition, when seated it can be difficult to reach certain objects on counters and/or shelves. The lifting or lowering during sitting or by standing can substantially increase the freedom of action of the user of the wheelchair to reach such items. As a result, there have been many attempted designs for wheelchairs that allow the user to assume an elevated, upright, standing position. For example, U.S. Pat. No. 7,708,093 discloses a motorized wheelchair with stand-up capability that includes a telescoping cylinder connected to the seat to create a lifting force to push the seat from an essentially horizontal position to an essentially vertical position that transitions the lifting mechanism as well to a collapsed parallelogram orientation when vertical. These designs have suffered from drawbacks such as excessive complexity, high manufacturing costs, undue size and weight, lack of fully effective systems for safely assuming standing and sitting positions and other shortcomings.

In addition to the adverse effects of sitting for long periods of time, most wheelchairs require the user to be removed from the wheelchair in order to use the lavatory. This can be nearly impossible for the person confined to the wheelchair to achieve on their own, and thus requires another person to help transfer the wheelchair user to the lavatory. This is not always possible if a trusted person is not available and can be demoralizing even if one is. Bathrooms that are designed for people in wheelchairs are also often too small to readily maneuver larger chairs, also increasing the difficulty of alternate wheelchair designs. Although alternate designs have been developed to allow the user to lavatory while still sitting on the wheelchair, many of these designs are also not practicable and can be unsanitary. For example, CN102232895A discloses a wheelchair with a split seat 12 that include a left seat cushion 121 and a right seat cushion 122 connected to actuators 51, 52, that push the left cushion and right cushion outward to form an opening through which the person can toilet if the wheelchair is positioned over the lavatory. However, the user is sitting on the left and right seat cushions 121 122 during use, and the opening created is extends the depth of the chair, making seating uncomfortable during use.

### SUMMARY

An assistive wheelchair that provides increased independence to wheelchair bound individuals by enabling stand-up ability, vertical height adjustment while seated, independent toileting that is comfortable, is easy for the user to operate, and that provides a stable but not cumbersome construction is disclosed herein.

The assistive wheelchair includes a verticalization system to move the user from a sitting to a more vertical position by tilting the seat in a manner that maintains the proper center of gravity. The verticalization system also allows the user to move the seat up and down without modifying its tilt angle, in order to change the height of the seat. Finally, an opening system that provides for transversal movement of the wheels, allowing the wheelchair to open up by increasing the base of the wheelchair while in use, in order to create space wide enough between the wheels for the lavatory, while also maintaining a smaller footprint for all-day usage is provided.

In one exemplary embodiment in addition to the main wheels the wheelchair includes a front pair and a rear pair of omni-wheels, and a pair of lifting linear actuators operatively connected to each rear omni-wheel, which when lowered raise the two drive wheels so that the front and rear omni-wheels can be moved transversely to the chair by lead screws moving in opposing directions in order to increase the width of the base and the opening between the drive wheels so that the base of the wheelchair can be placed over the lavatory.

In an exemplary embodiment two additional rear actuators, and two front actuators are each attached to a multi-bar system in order to raise the chair either at an angle or level to increase the height while maintaining a proper center of gravity during use.

In another exemplary embodiment the seat includes a trap door that is lowered such that the central portion of the seat moves underneath the chair and is then slid longitudinally out from the base for toileting while the user is sitting on the seat of the wheelchair.

The ability for the wheelchair to widen the base while in use for toileting and to transition between accommodation for a seated position and a standing position that also allows movement while standing provides increased independence to the user.

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments and are incorporated in and constitute a part of this specification but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labeled in every figure.

FIG. 1 is a front, perspective view of the assistive wheelchair according to a first exemplary embodiment with the seat door closed and the wheels in an initial, closed position;

FIG. 2 is a front plan view of the assistive wheelchair of FIG. 1;

FIG. 3 is a right, side view of the assistive wheelchair of FIG. 1;

FIGS. 4A, 4B and 4C are respective front, rear, and side views in partial cross-section of the seat assembly of FIG. 1;

FIG. 5 is a bottom, perspective view of the assistive wheelchair of FIG. 1;

FIG. 6 is a front, perspective view in partial cross-section of the assistive wheelchair of FIG. 1;

FIG. 7 is a rear, perspective view of the assistive wheelchair of FIG. 1;

FIG. 8 is a front plan view of the assistive wheelchair of FIG. 1 with the seat door closed and the wheels in a second, accessible position;

FIG. 9 is a bottom, perspective view of the assistive wheelchair of FIG. 8;

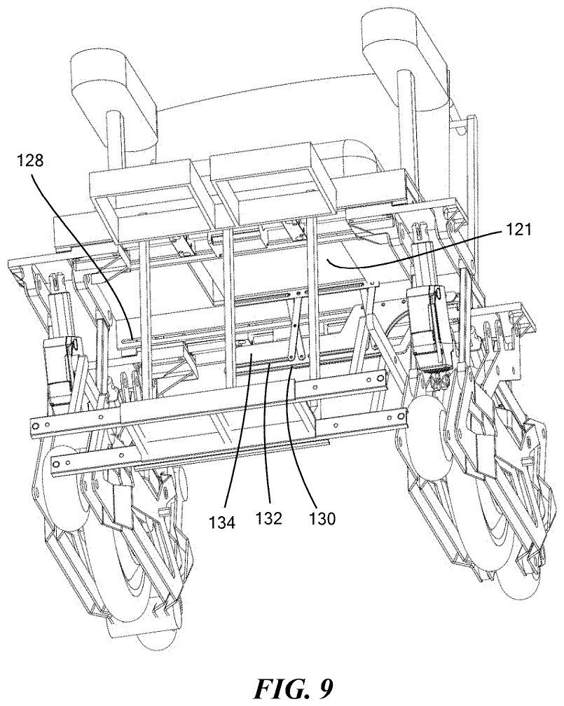

FIGS. 10A, 10B and 10C are respective front, rear, and side views in partial cross-section of the seat assembly of FIG. 8;

FIG. 11 is a front, perspective view of the assistive wheelchair of FIG. 1, with the seat door lowered and ready to open;

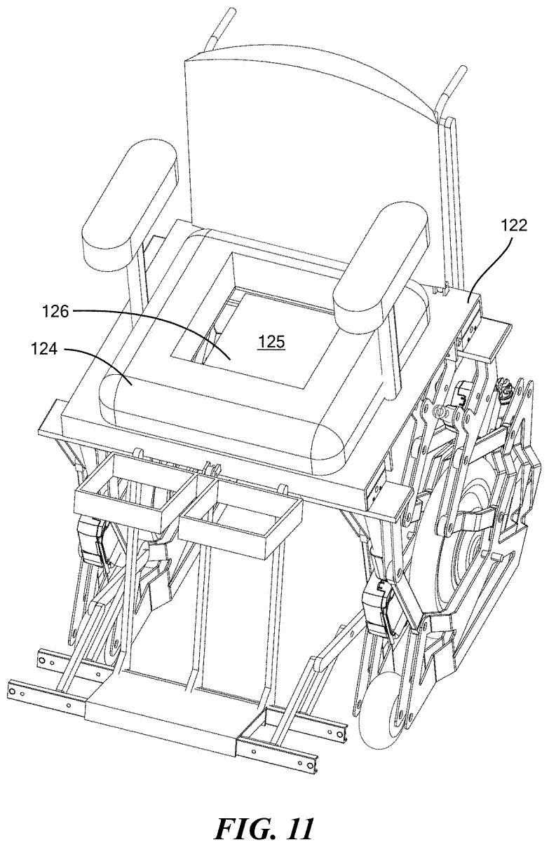

FIG. 12 is an enlarged perspective view of the bottom of the seat door of FIG. 11 and front linear actuator;

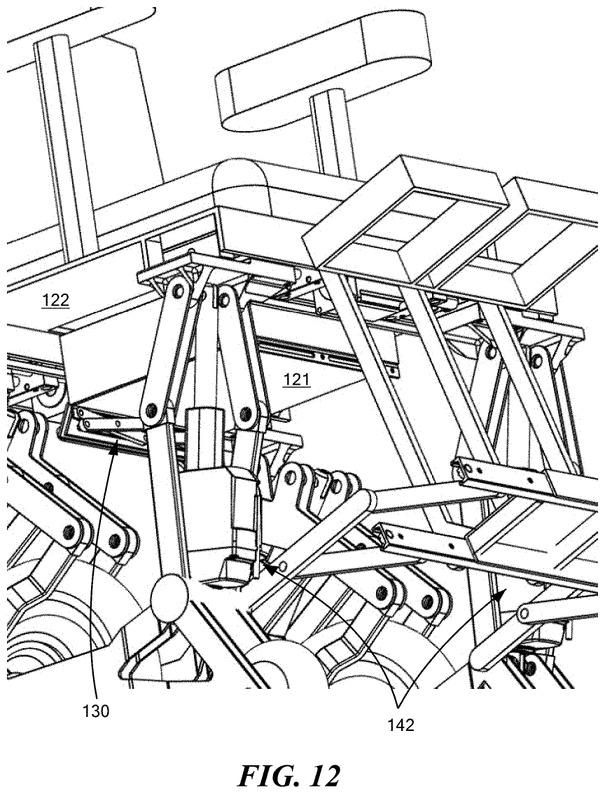

FIG. 13, is an enlarged, perspective rear view of the assistive wheelchair of FIG. 11 including the lowered seat door and rear omni wheels;

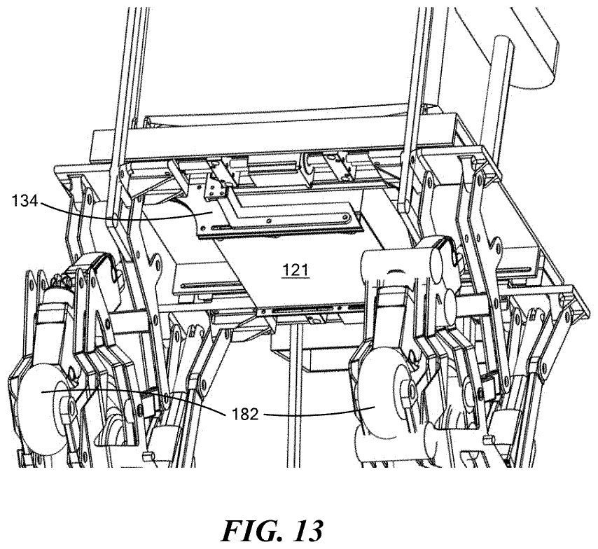

FIGS. 14A, 14B and 14C are respective front, rear, and side views in partial cross-section of the seat assembly of FIG. 11;

FIGS. 15A, 15B and 15C are respective front, rear, and side views in partial cross-section of the seat assembly of FIG. 1 illustrating partial movement of the central seat after being lowered;

FIG. 16 is an enlarged, front perspective view of the assistive wheelchair of FIG. 1 with the seat door completely open;

FIG. 17 is a bottom, perspective view of the assistive wheelchair of FIG. 16;

FIGS. 18A, 18B and 18C are respective front, rear, and side views in partial cross-section of the seat assembly of FIG. 16;

FIG. 19 is a front plan view of the of the assistive wheelchair of FIG. 1 with the seat door fully open, the wheels in the second, accessible position, and the chair raised parallel to the ground/floor;

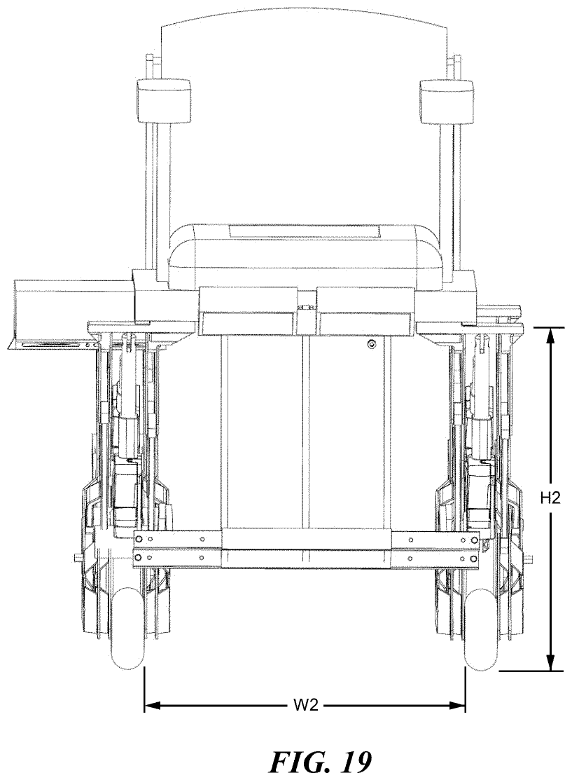

FIG. 20 is a right, side perspective view of the assistive wheelchair of FIG. 1 with the seat door closed, the wheels in the second, accessible position, and the chair raised at an angle;

FIG. 21 is a front plan view of the of the assistive wheelchair of FIG. 20;

FIG. 22 is a right, side view of the assistive wheelchair of FIG. 20;

FIG. 23 is a right, perspective view of the assistive wheelchair of FIG. 1 with the seat door closed, the wheels in the second, accessible position, and the chair raised substantially parallel with the floor;

FIG. 24 is a right, side view of the assistive wheelchair of FIG. 23; and

FIG. 25 is a front plan view of the of the assistive wheelchair of FIG. 23.

### DETAILED DESCRIPTION OF THE ILLUSTRATIVE EMBODIMENTS

The examples of the apparatus and method discussed herein are not limited in application to the details of construction and the arrangement of components set forth in the following description or illustrated in the accompanying drawings. It will be understood to one of skill in the art that the apparatus and method is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting. Any references to examples, embodiments, components, elements or acts of the system and method herein referred to in the singular may also embrace embodiments including a plurality, and any references in plural to any embodiment, component, element or act herein may also embrace embodiments including only a singularity (or unitary structure). References in the singular or plural form are not intended to limit the presently disclosed system and device, its components, acts, or elements. As used herein, the singular forms “a”, “an” and “the” are intended to include the plural forms as well, unless the context clearly indicates otherwise. The use of “including,” “comprising,” “comprises,” “having,” “containing,” “involving,” and variations thereof in the specification is meant to encompass the items listed thereafter and equivalents thereof but do not preclude the presence or addition of one or more other features or items. References to “or” may be construed as inclusive so that any terms described using “or” may indicate any of a single, more than one, and all of the described terms.

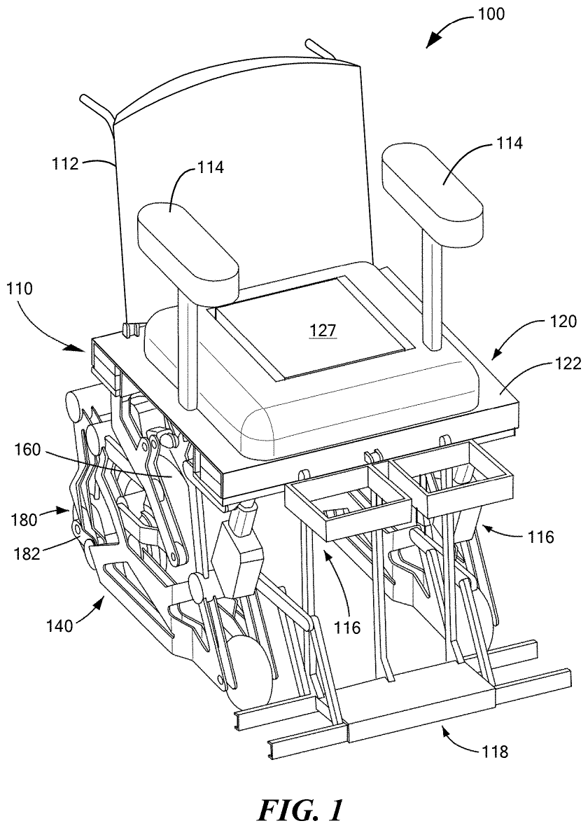

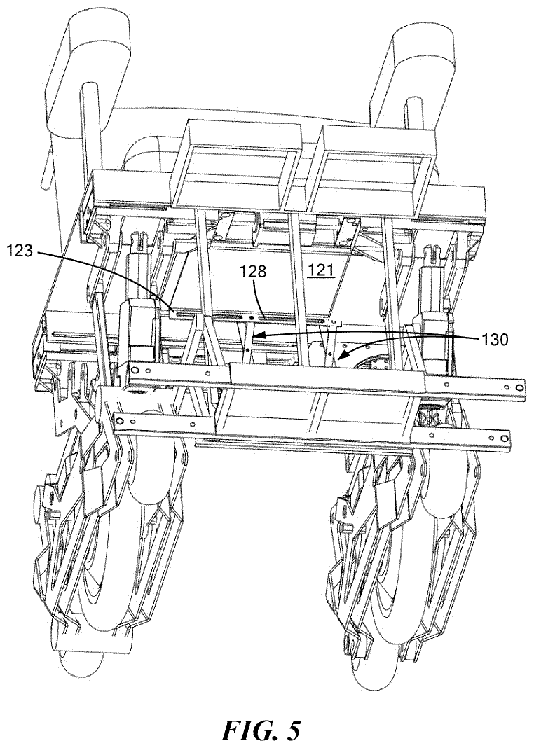

Referring initially to FIGS. 1-5, a motorized assistive wheelchair 100 is disclosed including conventional components such a base 110, a back rest 112, armrests 114, leg supports 116 and footplate 118 along with a pair of secondary front wheels 162 and drive wheels 160 driven by a motor 170 to provide movement of the wheelchair 100. The assistive wheelchair according to the present disclosure further includes a movable seat assembly 120 supported by base 110, a verticalization system 140 constructed to move the seat assembly 120 both vertically to increase and lower the height of the seat assembly 120 and also from a position parallel to the ground to an orientation that is more vertical by tilting the seat assembly 120 relative to the ground, and an opening system 180 that when engaged lifts the main drive wheels 160 by engaging secondary rear lifting wheels 182 with the ground and thereafter secondary lifting wheels 182 are moved transversely to the wheelchair base 110 to increase the width of the base 110 in order to create an opening “W2” wide enough between the drive wheels 160 so that the lavatory fits within the opening of the base 110.

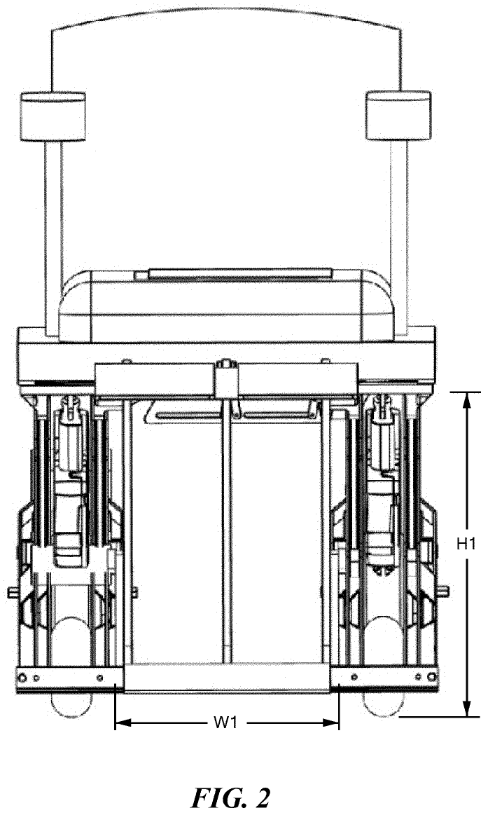

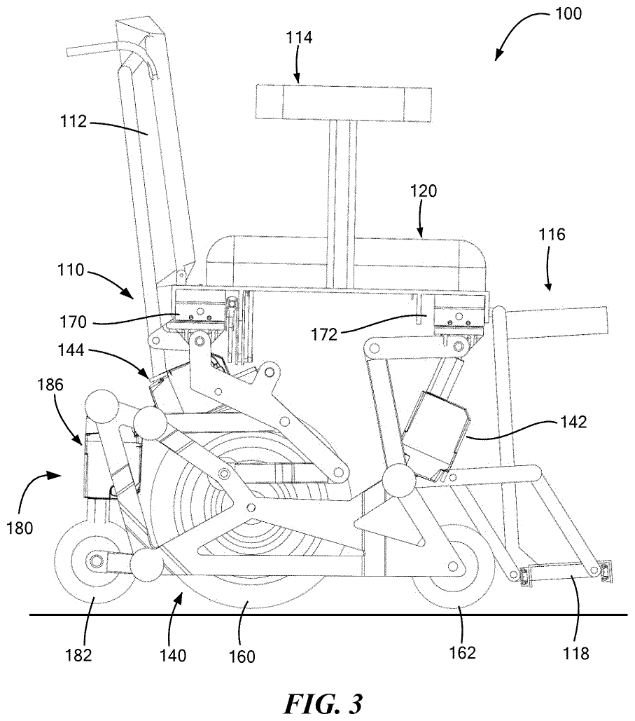

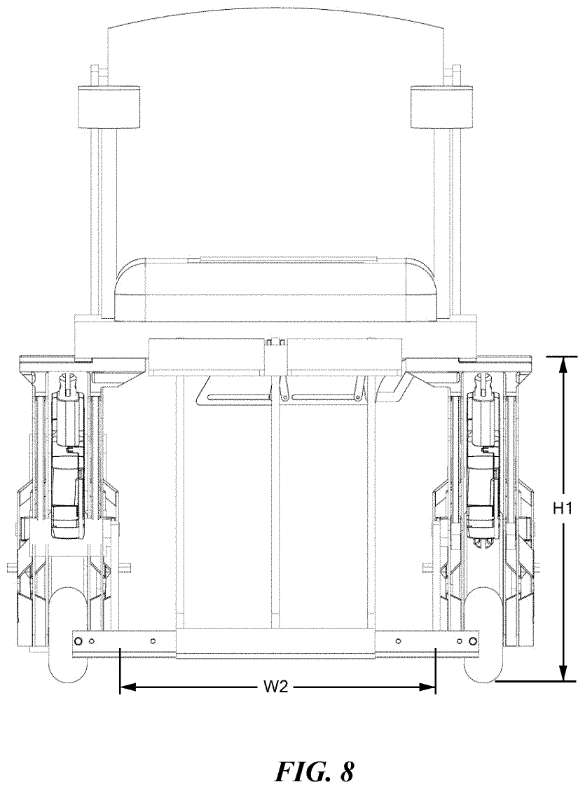

Prior to toileting, the width “W” of the opening of the wheelchair base 110 must be widened so that it can fit over the lavatory. That is, each side of the base 110 and corresponding drive wheels 160 must be moved to widen operational opening W1 (FIG. 2), i.e., the width of the opening when the user is operating the wheelchair for mobility, to the toileting opening width W2 that would fit over the lavatory, as shown in FIG. 8. In order to achieve this, opening system 180 including rear lifting wheels 182, forward secondary wheels 162, lifting actuators 186, transverse actuator assembly 183, and sliding guide plates 188 are utilized. As best shown in FIG. 3, rear lifting wheels 182 do not touch the ground or floor on which the wheelchair travels during operation of the wheelchair for mobility. Both rear lifting wheels 182 and forward secondary wheels 162 can move transversely to the body of the wheelchair as well as longitudinally thereto, i.e. in the same direction as the drive wheels 160. In order to widen the wheelchair base 110, the drive wheels 160 must first be lifted from engagement with the floor/ground. To do this rear lifting actuators 186 are extended until rear lifting wheels 182 not only engage the floor/ground but provide enough force to lift drive wheels 160 from engagement with the floor/ground.

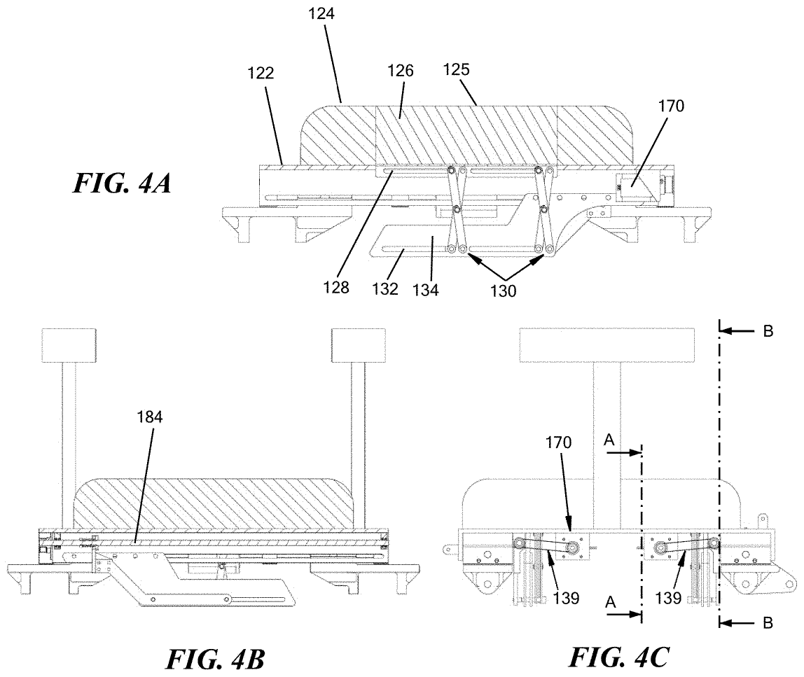

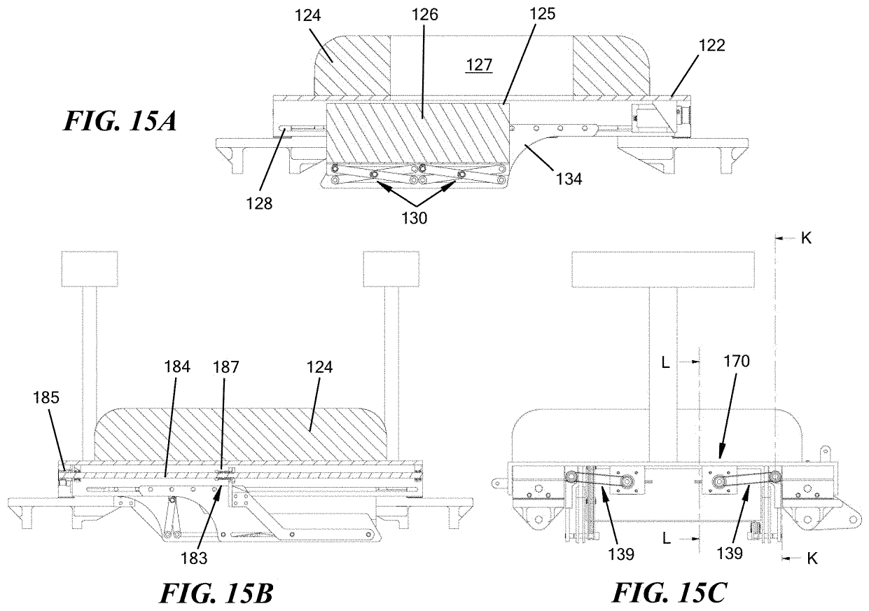

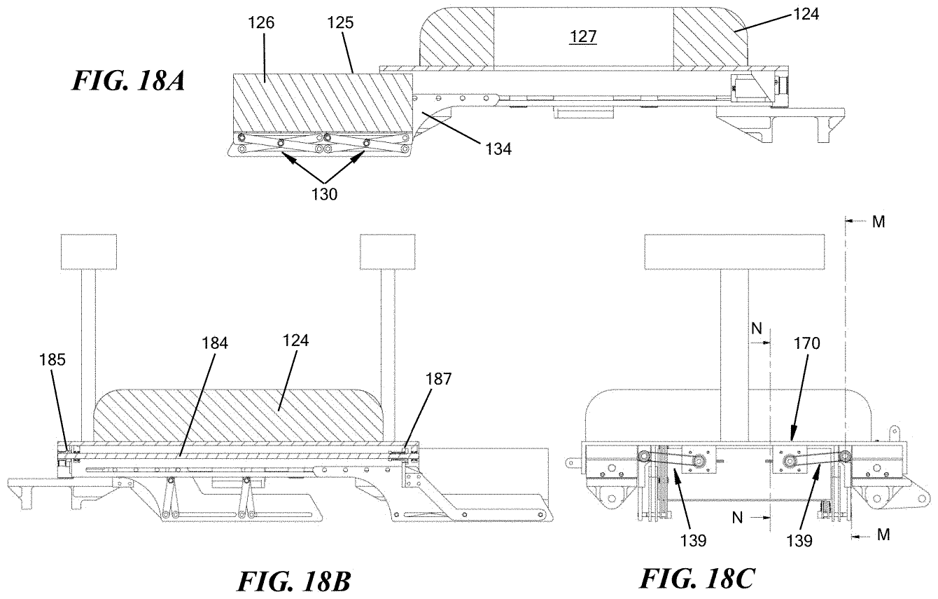

Once the drive wheels 160 are lifted, transverse actuator assembly 183 that includes lead screw nuts 185, 187 and a pair of parallel lead screws 184 (FIGS. 4B, 10B, 14B, 15B, and 18B), each received within sliding guide plates 188 to aid the transverse actuator assembly, are utilized to open the wheelchair base 110 in the present embodiment. Alternatively, other methods of opening the wheelchair base may be utilized, for example a hydraulic or pneumatic actuator including a piston, cylinder, and valves, or the like. In the present exemplary embodiment, the transverse actuator assembly and sliding guide plates are both supported within parallel channels 172 (FIG. 3) formed under the seat base 122, so that in use they can extend from under the seat base 122 as the wheelchair base is widened, without effecting the width of the seat base. Lead screws 184 are powered by the motor 170 in order to open the wheelchair base 110 with sufficient force to overcome any friction that the rear lifting wheels 182 and front secondary wheels 162 may possess, while keeping the base and drive wheels 160 properly aligned. As the lead screws 184 begin rotating in a first direction the secondary wheels 162 and the rear lifting wheels 182 are moved transversely such that each of the drive wheels 160 are moved outwardly, away from the center of the wheelchair base 110 and into the W2 position (FIG. 8). The lifting actuators 186 can then be moved back into their retracted position to disengage the rear lifting wheels 182 from the floor/ground and return the drive wheels 160 into engagement with the floor/ground.

In the present embodiment the secondary wheels 162 and the rear lifting wheels 182 may be omni-wheels, which have small discs (i.e. rollers) around the circumference that are perpendicular to the turning direction. This allows the wheels to be driven with full force and also allows them to move laterally with ease. Alternately, the wheels may be mecanum wheels, casters, or any wheel that provides for both driving and lateral movement, as would be known to those of skill in the art. While the secondary wheels 162 and the rear lifting wheels 182 are moving laterally, the drive wheels 160 that are lifted are moving in conjunction with the wheelchair base 110. Prior to positioning the wheelchair 100 over the lavatory an opening must be present in the seat assembly 120 so that the user may toilet without leaving the main seat 124 of the wheelchair.

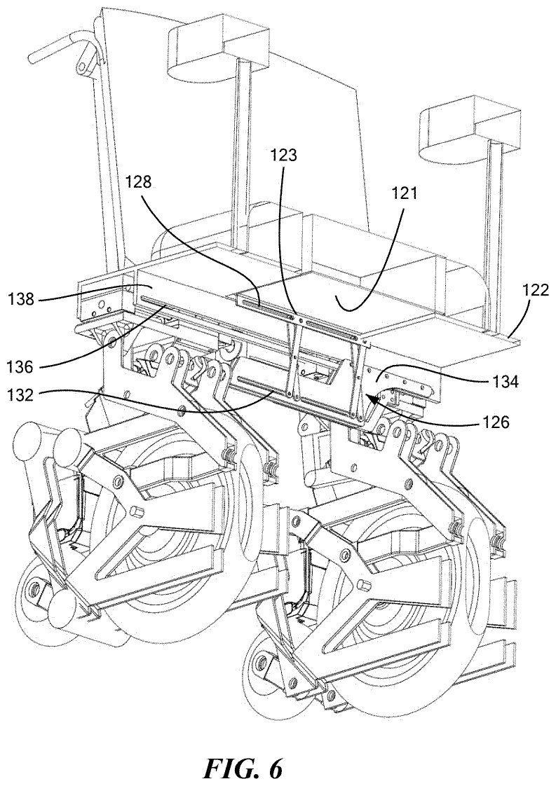

The seat assembly 120 includes seat base 122 that supports the main seat 124 the user sits on while utilizing the wheelchair 100, as well as a trap door 126 that is centrally located within opening 127 in the main seat 124. Before using the lavatory, trap door 126 is lowered underneath the wheelchair 100 and slid longitudinally out from the base 122 while the user is sitting on the main seat 124. As best shown in FIG. 6, trap door 126 is supported on a base plate 121 having a flange 123 extending from a rear edge thereof. In order to drop the trap door 126 below the seat base 122 a pair of linkages 130 attached to both the base plate 121 and a sliding plate 134 are provided. As best illustrated in FIGS. 4A-6 first slot 128 is formed in the flange 123 for engaging one end of each of the linkages 130. In the present embodiment the linkages 130 are pantograph linkages, although other linkages or movable members may be utilized as would be known to those of skill in the art. The other end of each of the pantograph linkages 130 is received within a second slot 132 in sliding plate 134. Sliding plate 134 is movably supported within track 136 of shoulder 138 that extends from and is supported by the underside of seat base 122. To move the trap door seat 126 from the closed position to the fully open position, it must be moved into the lowered position first by the pantone linkages 130. As trap door seat 126 is lowered, each end of pantone linkages 130 moves within their respective slots 128 and 132.

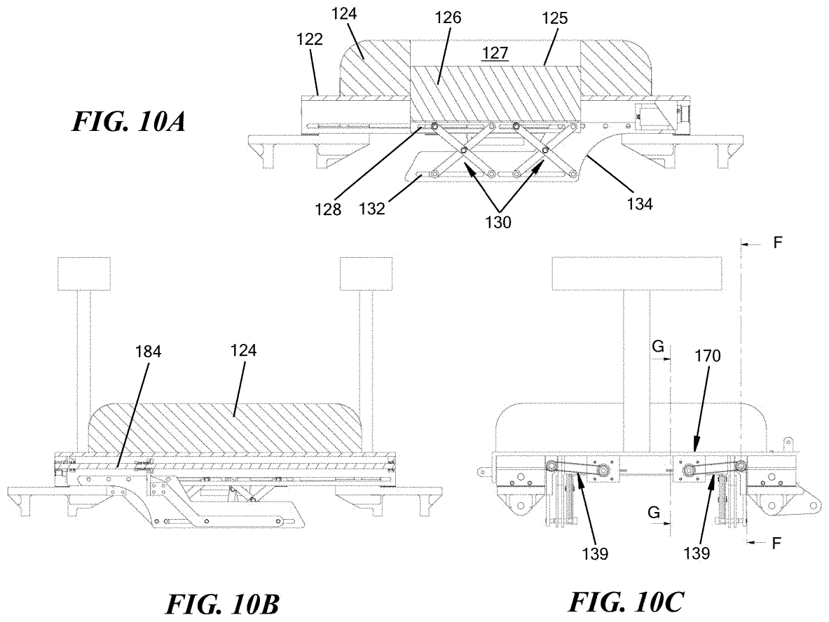

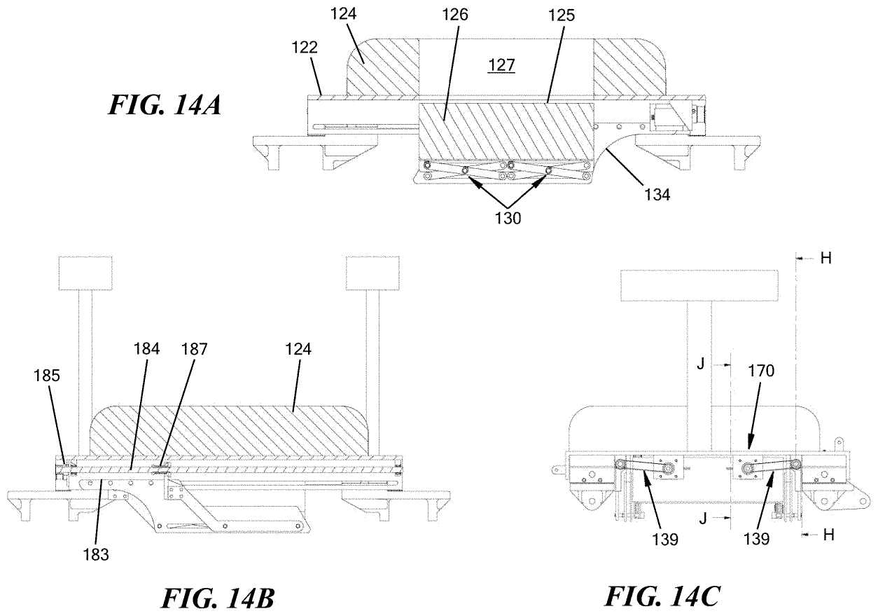

Referring to FIGS. 4A-4C, the trap door seat 126 is shown in the closed position and the pantone linkages 130 are compressed vertically such that each linkage forming the “X” is pivoted into an upward position as shown in FIG. 4A. To lower trap door seat 126 the pantone linkages 130 are moved by motor 170 such that the linkages forming the “X” widen, moving the trap door seat 126 down into an intermediate position where a top surface 125 of the seat 126 is within the opening 127 formed in main seat 124 as best shown in FIG. 10A. As the linkages 130 continue to move, they flatten, forming a horizontally compressed “X,” as best shown in FIG. 14A, such that the top surface 125 of trap door 126 is below the seat base 122. Once positioned below the seat base 122 the trap door seat 126 is ready to move longitudinally out from under the base 122.

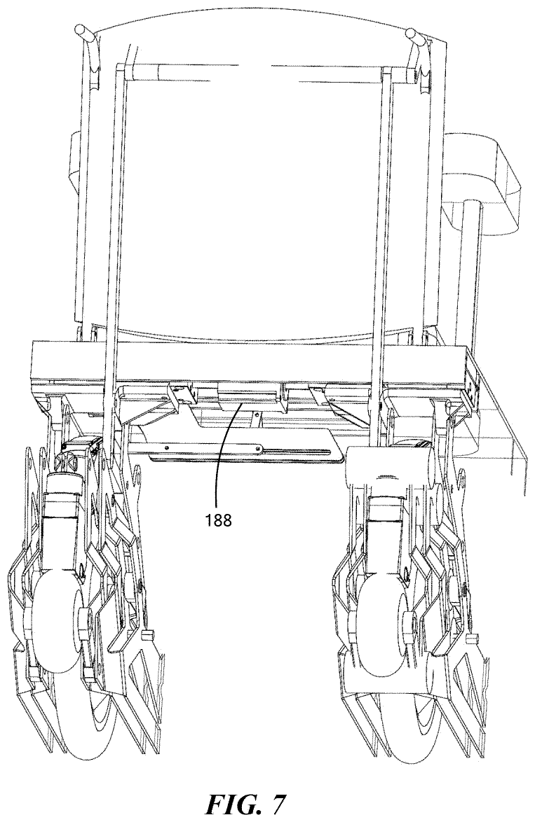

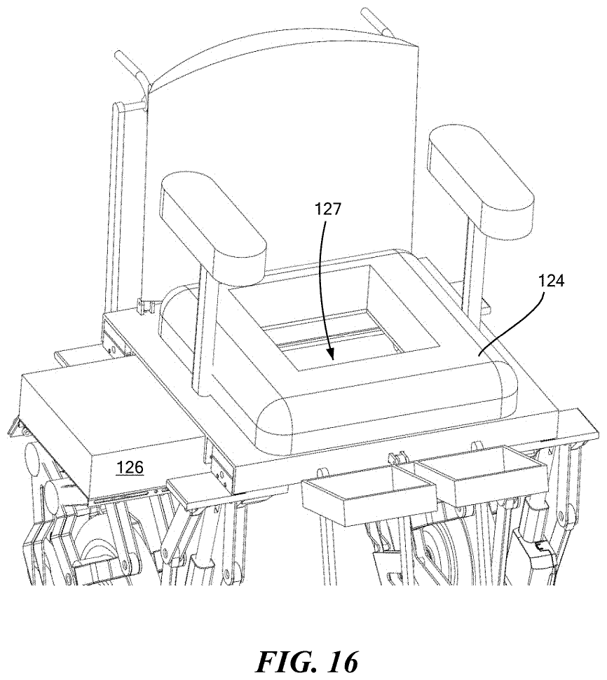

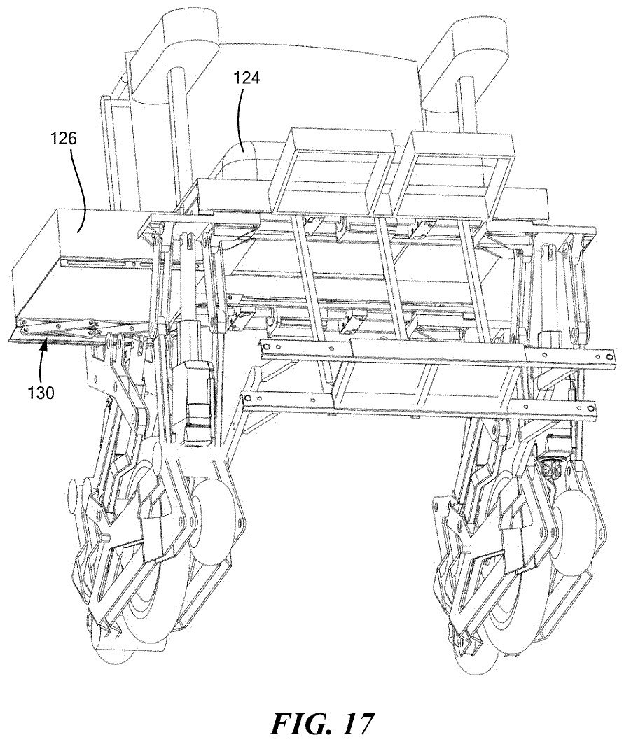

Sliding plate 134 is movably supported within track 136 of shoulder 138 that extends from and is supported by the underside of seat base 122. A pair of pulleys 139 and motor 170 are provided in order affect movement of the sliding plate 134 from the position shown in FIGS. 1-7, to the fully open position as shown in FIG. 16-18C. As illustrated, when sliding plate 134 reaches the end of track 136 it is no longer substantially under seat base 122. At this point opening 127 is no longer blocked by trap door 126, and the user can then back the wheelchair 100 with the widened opening W2 over the lavatory and toilet without fear of getting waste on the top surface 125 of the trap door seat 126.

Once toileting has been completed the trap door seat 126 and the wheelchair base 110 are both moved into their operational position. The wheelchair 100 is first moved from its position over the lavatory and away from it by the user. The trap door seat may then be moved back into position. To move the trap door seat 126 back the reverse action is taken. Namely, the trap door seat 126 is moved back under opening 127 by the sliding plate 134 reversing direction and moving within track 136 back under seat base 122. The pantone linkages 130 likewise reverse movement to raise the trap door seat 126 until the top surface 125 is aligned with the top surface of the main seat 124. The user can then move the wheelchair back to its original opening width, W1 for operational use. To return the wheelchair back to the operation position the reverse action likewise occurs. Namely, after again engaging lifting actuators 186 and lifting the drive wheels 160 as described above, the lead screws 184 begin rotating in an opposite direction to move both the secondary wheels 162 and the rear lifting wheels 182 transversely such that each of the drive wheels 160 are moved inwardly, toward the center of the wheelchair base 110 and back into the W1 position (FIG. 2).

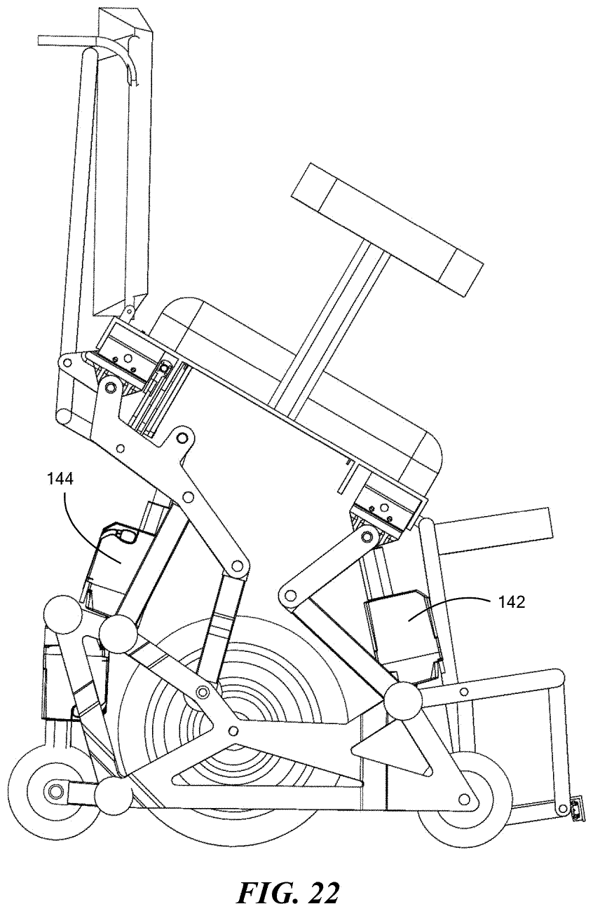

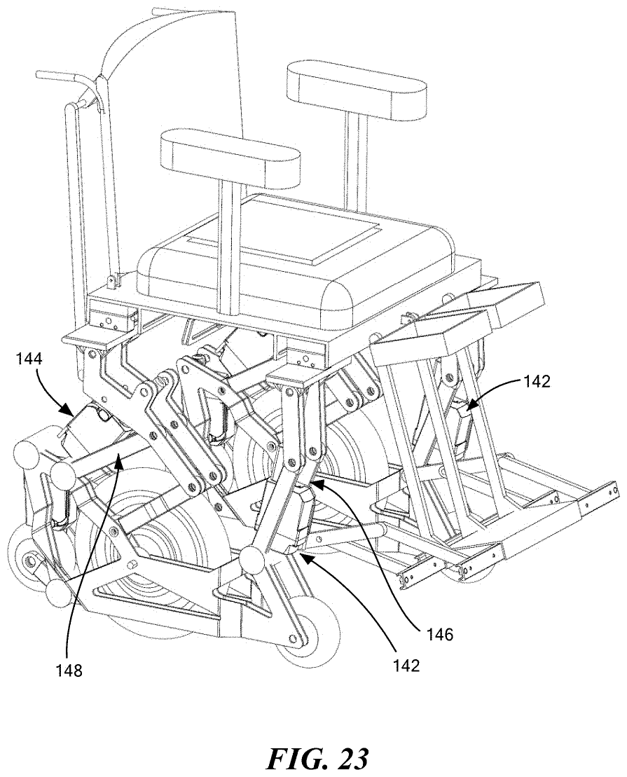

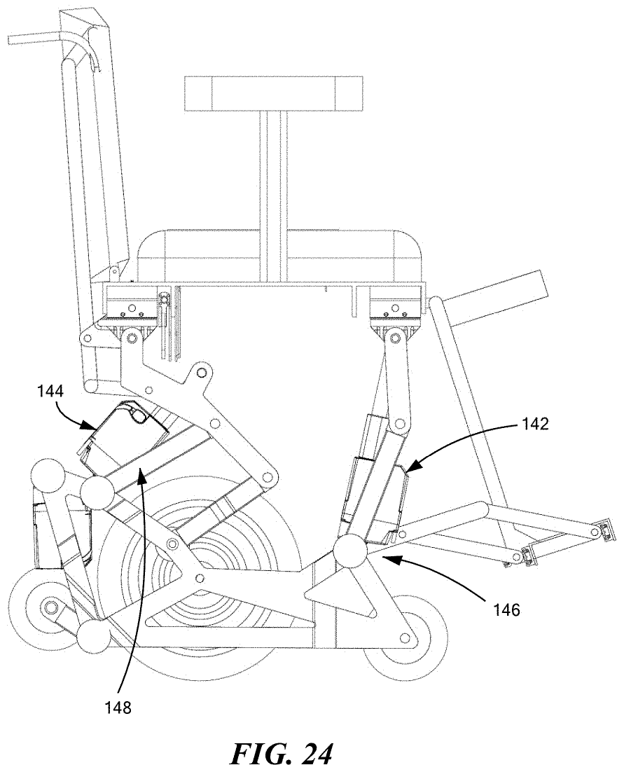

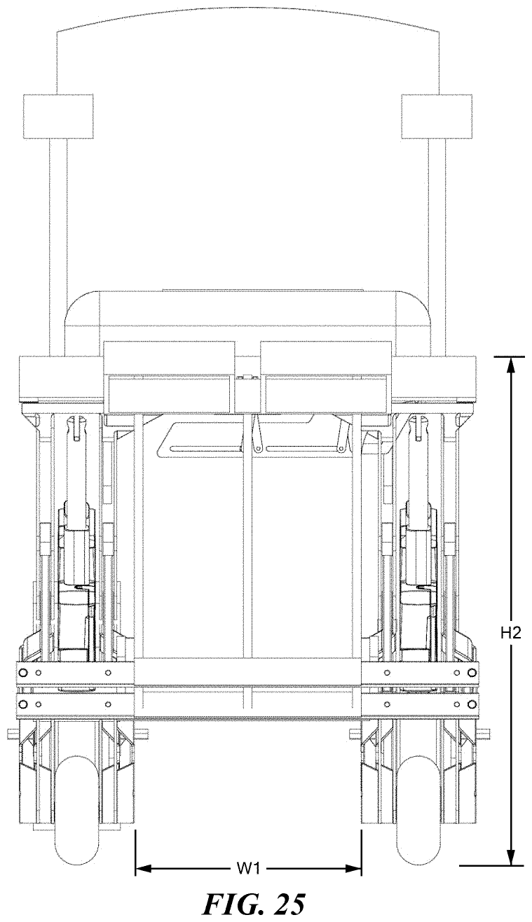

In some instances, in order to toilet the height “H” of the seat assembly 120 from the floor/ground may also need to be increased. The wheelchair 100 includes a verticalization system 140 that allows the user to move the seat assembly 120 up and down relative to the floor/ground in order to change the height of the seat assembly 120 from an operational height H1 (FIG. 2) to a toileting height H2 (FIG. 25). Referring now to FIGS. 3, 20-24 verticalization system 140 includes a pair of actuators on each side, front actuators 142 and rear actuators 144 that connect to multi bar linkage assemblies 146, 148 respectively, which are connected to the seat base 122. In order to raise the height of the seat assembly 120 the front and rear actuators 142, 144 are extended by use of the motor in a coordinated fashion, which results in the movement of linkage assemblies 146, 148 from the lower, operational height (FIG. 2) to an increased height H2 (FIG. 25). As illustrated in FIGS. 23-25, when moved vertically in a coordinated fashion, the seat assembly 120 remains level, i.e. substantially parallel to the floor/ground. The increased height may be used for example for toileting or for other reasons, such as increasing the height to extend the reach of the user to higher surfaces. The coordinated use of the front and rear actuators 142, 144 allows the vertical translation of the seat assembly 120, both up and down by the user. If verticalization of the user is desired, for example into a substantially vertical or standing position, non-coordinated use of front and rear actuators 142, 144 is required.

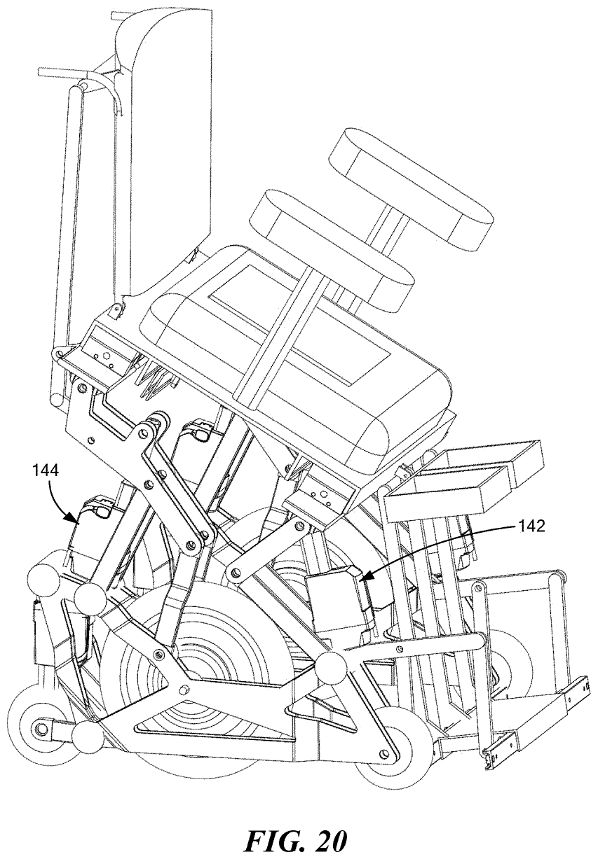

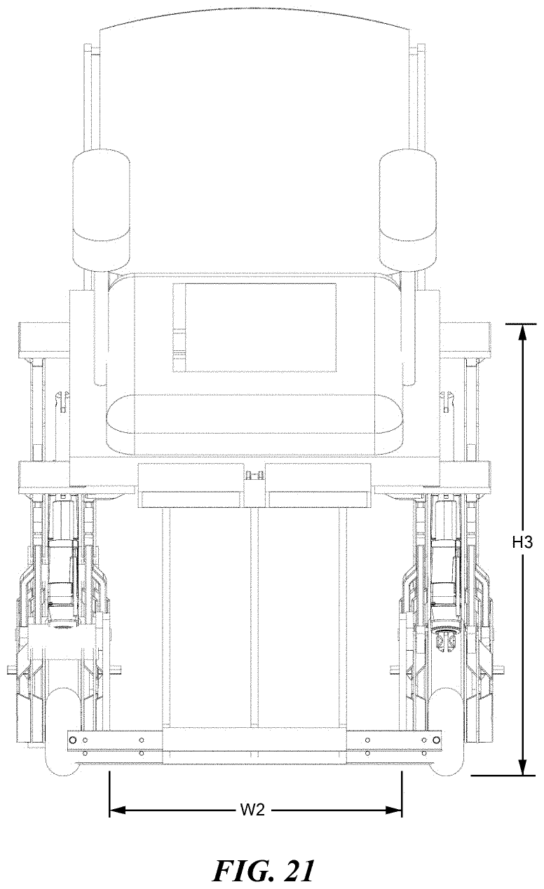

Referring now to FIGS. 20-22, exemplary embodiments of the verticalization system where seat assembly 120 is angled, i.e. tilted relative to the floor/ground in order to raise the user into a more vertical position are illustrated. In these embodiments, depending upon the desired verticalization the angle of the seat assembly 120 can be adjusted by increasing and/or decreasing the extension of the rear actuator 144. As will be appreciated, the greater the difference between the extension of the rear actuator 144 vs. the front actuator 142, the greater the angle of the seat assembly 120 and the more vertical the position of the user. FIG. 21 illustrates one exemplary embodiment of the increased height (“H3”) of the rear portion of the seat assembly 120 to the ground/floor. The extensions of the actuators 142, can be adjusted 144 by the user or may optionally be pre-set by the manufacturer. The use of multi-bar linkages 146, 148 allows the wheelchair 100 to maintain a proper center of gravity both during verticalization and during movement once the user is in the more upright, or vertical position. Other designs for the linkage assemblies 146, 148 are possible to maintain the proper center of gravity, both increasing the number of linkages and/or changing the lengths of the linkages, depending upon the overall design of the wheelchair, for example for an adult or child.

As will be appreciated, the assistive wheelchair described herein provides increased independence to wheelchair bound individuals by enabling stand-up ability, vertical height adjustment while seated, independent toileting that is comfortable, and ease of use while remaining stable.

Having thus described several aspects of at least one example, it is to be appreciated that various alterations, modifications, and improvements will readily occur to those skilled in the art, without departing from the spirit and scope of the invention as defined by the appended claims. Therefore, the claims are not to be limited to the specific examples depicted herein. For example, the features of one example disclosed above can be used with the features of another example. Furthermore, various modifications and rearrangements of the parts may be made without departing from the spirit and scope of the underlying inventive concept. For example, the geometric configurations disclosed herein may be altered depending upon the application, as may the material selection for the components. Such alterations, modifications, and improvements are intended to be part of this disclosure and are intended to be within the scope of the examples discussed herein. Thus, the details of these components as set forth in the above-described examples, should not limit the scope of the claims.

Further, the purpose of the Abstract is to enable the U. S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. An assistive wheelchair comprising:
a movable seat assembly including a seat base;
a back rest;
a leg support;
a pair of drive wheels driven by a motor; and
an opening system including rear lifting wheels, forward secondary wheels, lifting actuators, and a transverse actuator assembly constructed and arranged to move the rear lifting wheels transversely to a wheelchair base to increase the width of the wheelchair base in order to create an opening between the drive wheels of sufficient width so that a lavatory fits within the opening of the wheelchair base.

2. The assistive wheelchair of claim 1, wherein the lifting actuators are extendable a sufficient distance to engage the rear lifting wheels with the ground and provide sufficient force to lift the pair of drive wheels from engagement with the ground.

3. The assistive wheelchair of claim 1, wherein the opening system further includes a pair of sliding guide plates supported on an underside of the seat base.

4. The assistive wheelchair of claim 3, wherein the transverse actuator assembly is supported on the underside of the seat base and includes lead screw nuts and a pair of lead screws that are sized to be received within sliding guide plates.

5. The assistive wheelchair of claim 1, wherein the seat assembly further includes a main seat constructed and arranged for a user to sit on, an opening disposed through the main seat, and a moveable trap door.

6. The assistive wheelchair of claim 5, further comprising a sliding plate supported by the underside of the seat base, and wherein the trap door is supported on a base plate.

7. The assistive wheelchair of claim 6, further comprising a pair of linkages, each of the linkages received at one end within a first track disposed in the base plate supporting the trap door and received at a second end within a second track disposed in the sliding plate, wherein movement of the linkages with the first and second tracks lowers the trap door such that a top surface of the trap door is below the seat base.

8. The assistive wheelchair of claim 7, wherein the sliding plate is movably supported within a track in a shoulder supported by the underside of seat base from a closed position where the sliding plate is positioned substantially under the seat base to an open position where the sliding plate is not substantially under the seat base such that the opening is no longer blocked by the trap door.

9. The assistive wheelchair of claim 8, further comprising a pair of pulleys powered by a motor to affect movement of the sliding plate from the closed position to the open position.

10. The assistive wheelchair of claim 1, further comprising a verticalization system constructed and arranged to move the seat assembly both vertically, to increase and lower the height of the seat assembly, and also to move the seat assembly from a position substantially parallel to the ground to an orientation that is tilted relative to the ground.

11. The assistive wheelchair of claim 10, wherein the verticalization system includes a pair of actuators disposed on each side of the wheelchair, the pair of actuators including front actuators operatively connected to a first multi-bar linkage assembly and rear actuators operatively connected to a second multi-bar linkage assembly, the linkage assemblies being connect to the seat base wherein to raise the height of the seat assembly the front actuators and the rear actuators are extended substantially the same amount in a coordinated fashion by a motor connected thereto, and wherein to tilt the seat assembly the rear actuators are extended a further distance than the front actuators.

12. An assistive wheelchair comprising:
a movable seat assembly including a seat base, a main seat constructed and arranged for a user to sit on, an opening disposed through the main seat, and a trap door movable in both a vertical and transverse direction;
a back rest;
a leg support;
a pair of drive wheels driven by a motor; and
an opening system including rear lifting wheels, forward secondary wheels, lifting actuators, and a transverse actuator assembly constructed and arranged to move the rear lifting wheels transversely to a wheelchair base to increase the width of the wheelchair base in order to create an opening between the drive wheels of sufficient width so that a lavatory fits within the opening of the wheelchair base.

13. The assistive wheelchair of claim 12, wherein the lifting actuators are extendable a sufficient distance to engage the rear lifting wheels with the ground and provide sufficient force to lift the pair of drive wheels from engagement with the ground.

14. The assistive wheelchair of claim 12, further comprising a sliding plate supported to the underside of the seat base, and wherein the trap door is supported on a base plate.

15. The assistive wheelchair of claim 14, further comprising a pair of linkages, each of the linkages received at one end within a first track disposed in the base plate supporting the trap door and received at a second end within a second track disposed in the sliding plate, wherein movement of the linkages with the first and second tracks lowers the trap door such that a top surface of the trap door is below the seat base.

16. The assistive wheelchair of claim 15, wherein the pair of linkages are pantograph linkages.

17. The assistive wheelchair of claim 16, wherein the sliding plate is movably supported within a track in a shoulder supported by the underside of seat base from a closed position where the sliding plate is positioned substantially under the seat base to an open position where the sliding plate is not substantially under the seat base such that the opening is no longer blocked by the trap door.

18. The assistive wheelchair of claim 17, further comprising a pair of pulleys powered by a motor to affect movement of the sliding plate from the closed position to the open position.

19. The assistive wheelchair of claim 18, further comprising a verticalization system constructed and arranged to move the seat assembly both vertically to increase and lower the height of the seat assembly and also to move the seat assembly from a position substantially parallel to the ground to an orientation that is tilted relative to the ground.

20. The assistive wheelchair of claim 12, further comprising a verticalization system constructed and arranged to move the seat assembly both vertically to increase and lower the height of the seat assembly and also to move the seat assembly from a position substantially parallel to the ground to an orientation that is tilted relative to the ground.
